(19) United States
(12) Patent Application Publication
(10) Pub. No.: US 2024/0305413 A1
(43) Pub. Date: Sep. 12, 2024

(54) Procedures For PUSCH Scheduling In Mobile Communications

(71) Applicant: MediaTek Singapore Pte. Ltd., Singapore (SG)

(72) Inventor: Mohammed S Aleabe Al-Imari, Cambridge (GB)

(21) Appl. No.: 18/272,191

(22) PCT Filed: Dec. 21, 2021
(86) PCT No.: PCT/CN2021/139850

§ 371 Date: Jul. 13, 2023

Related U.S. Application Data
(60) Provisional application No. 63/137,178, filed on Jan. 14, 2021.

(51) Int. Cl. H04L 1/1822; H04W 72/1268; H04W 72/232

(52) U.S. Cl. CPC H04L 1/1822; H04W 72/1268; H04W 72/232

(57) ABSTRACT

Various solutions for new procedures for physical uplink shared channel (PUSCH) scheduling in mobile communications are described. An apparatus performs a last PUSCH transmission of one or more PUSCH transmissions associated with a first hybrid automatic repeat request (HARQ) process. The apparatus also receives, after and not before the last PUSCH transmission, a downlink control information (DCI) signal scrambled by a specific radio network temporary identifier (RNTI) and scheduling a subsequent PUSCH transmission for the first HARQ process.

### CROSS REFERENCE TO RELATED PATENT APPLICATION

The present disclosure is part of U.S. National Stage filing of International Patent Application No. PCT/CN2021/139850, filed 21 Dec. 2021, which is part of a non-provisional application claiming the priority benefit of U.S. Patent Application No. 63/137,178, filed on 14 Jan. 2021, the content of which being incorporated by reference in its entirety.

### TECHNICAL FIELD

The present disclosure is generally related to mobile communications and, more particularly, to procedures for physical uplink shared channel (PUSCH) scheduling in mobile communications.

### BACKGROUND

Unless otherwise indicated herein, approaches described in this section are not prior art to the claims listed below and are not admitted as prior art by inclusion in this section.

In wireless communications, such as mobile communications based on the 3rd Generation Partnership Project (3GPP) specification(s) for 5th Generation (5G) New Radio (NR) and beyond, there is a restriction in Release 15 (Rel-15) of the 3GPP specification on scheduling a user equipment (UE) with another dynamic PUSCH before a first PUSCH with the same hybrid automatic repeat request (HARQ) process identification (ID) has been transmitted. In particular, the restriction specifies that the UE is not expected to be scheduled to transmit another PUSCH by downlink control information (DCI) format 0_0 or 0_1 scrambled by cell radio network temporary identifier (C-RNTI) or modulation coding scheme (MCS) C-RNTI (MCS-C-RNTI) for a given HARQ process until after the end of the expected transmission of the last PUSCH for that HARQ process. The intention of this restriction is to simplify UE implementation by excluding a back-to-back scheduling of PUSCHs with the same HARQ process ID. By back-to-back scheduling, it is meant that the UE would not expect another DCI scheduling a PUSCH for a given HARQ process ID unless the last PUSCH of that HARQ process has been transmitted. The restriction in the current 3GPP specification focuses only on PUSCHs that are scheduled with DCIs scrambled by C-RNTI or MCS-C-RNTI.

From the perspective of UE implementation, PUSCHs that are dynamically scheduled with DCIs scrambled by other radio network temporary identifiers (RNTIs) typically require the same complexity to handle the “back-to-back” scheduling of PUSCHs. However, there are two cases of dynamically scheduled PUSCHs that are not covered by the current restriction. In a first case, DCIs scrambled with temporary C-RNTI (TC-RNTI), which is used for scheduling the initial transmission and retransmission of Msg3, are not currently included in the restriction. These are dynamically scheduled PUSCHs, and the UE behavior is identical to PUSCHs scheduled with DCIs scrambled by C-RNTI. In a second case, DCIs scrambled by configured scheduling RNTI (CS-RNTI), when used for the second (or later) retransmission of the configured grant PUSCH (CG-PUSCH), are not currently included in the restriction. Similar to the first case, the subsequent retransmissions of a CG-PUSCH are considered dynamic PUSCHs. Therefore, there is a need for a solution pertaining to new procedures for PUSCH scheduling in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. That is, various schemes proposed in the present disclosure are believed to address issues pertaining to procedures for PUSCH scheduling in mobile communications. More specifically, various proposed schemes in accordance with the present disclosure aim to extend the current restriction to PUSCHs that are scheduled by DCIs scrambled by TC-RNTI and CS-RNTI (apart from the first retransmission of a CG-PUSCH).

In one aspect, a method may involve performing a last PUSCH transmission of one or more PUSCH transmissions associated with a given HARQ process. The method may also involve receiving, after and not before the last PUSCH transmission, a DCI signal scrambled by a specific RNTI and scheduling a subsequent PUSCH transmission for the given HARQ process.

In another aspect, a method may involve performing a last PUSCH transmission of one or more PUSCH transmissions scheduled with a DCI signal and associated with a first HARQ process. The method may also involve receiving the DCI signal scrambled by a specific RNTI and scheduling a subsequent PUSCH transmission for the first HARQ process. The method may further involve skipping the subsequent PUSCH transmission in an event that the DCI signal is received before the last PUSCH transmission.

In yet another aspect, a method may involve performing a last PUSCH transmission of one or more PUSCH transmissions associated with a first HARQ process and scheduled by an uplink (UL) grant in a random access (RA) response or by a DCI signal scrambled by a TC-RNTI. The method may also involve receiving the DCI signal scrambled by the TC-RNTI and scheduling a subsequent PUSCH transmission for the first HARQ process. The method may further involve skipping the subsequent PUSCH transmission in an event that the DCI signal is received before the last PUSCH transmission.

It is noteworthy that, although description provided herein may be in the context of certain radio access technologies, networks and network topologies such as 5G/NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under an implementation of the present disclosure.

FIG. 3 is a diagram of an example scenario under an implementation of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### OVERVIEW

Implementations in accordance with the present disclosure relate to various techniques, methods, schemes and/or solutions pertaining to procedures for PUSCH scheduling in mobile communications. According to the present disclosure, a number of possible solutions may be implemented separately or jointly. That is, although these possible solutions may be described below separately, two or more of these possible solutions may be implemented in one combination or another.

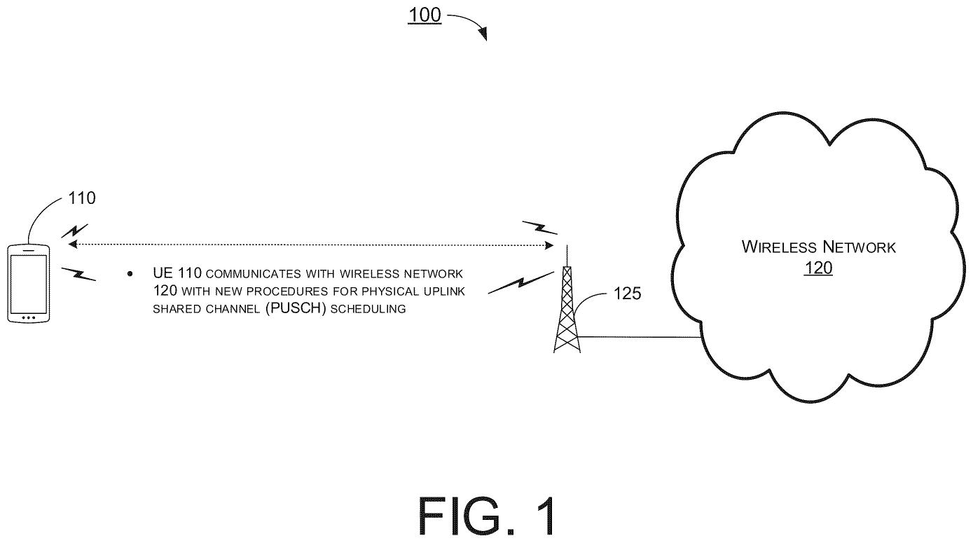

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to procedures for PUSCH scheduling in mobile communications, as described below.

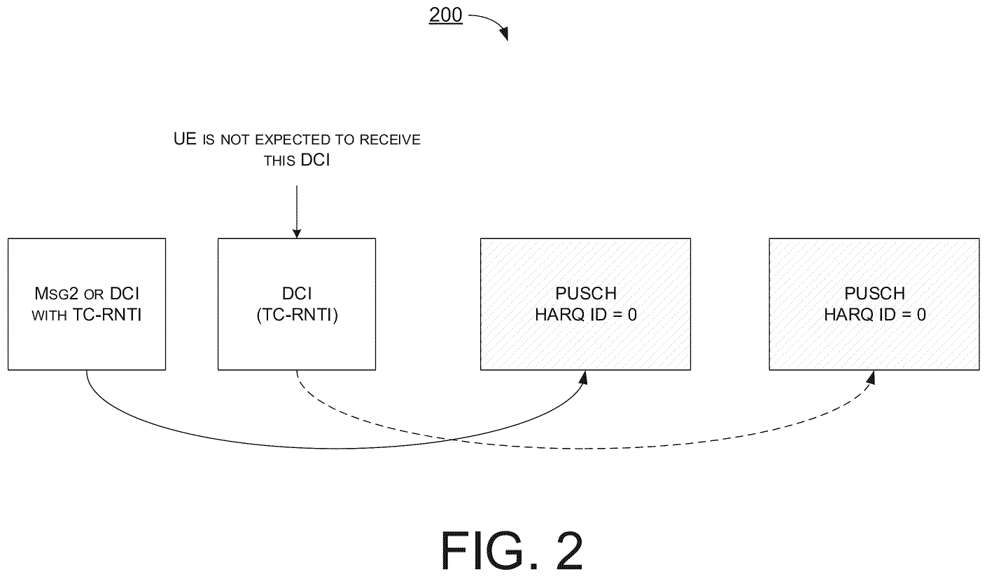

Under a first proposed scheme in accordance with the present disclosure, UE 110 may not expect to receive a DCI scrambled (e.g., cyclic redundancy check (CRC) scrambled) by a TC-RNTI scheduling a transmission of a PUSCH for a given HARQ process until after an end of an expected transmission of a last PUSCH for that HARQ process. FIG. 2 illustrates an example scenario 200 under this proposed scheme. Referring to FIG. 2, UE 110 is not expected to receive the DCI scheduled by a TC-RNTI. In some cases, the aforementioned restriction may be only applicable in case that the last PUSCH was scheduled with a DCI scrambled by a TC-RNTI (e.g., the restriction is not applicable in an event that the last PUSCH was scheduled with Msg2).

As an example of an implementation of the first proposed scheme, UE 110 is not expected to be scheduled to transmit another PUSCH by a DCI format 0_0 that is CRC scrambled by a TC-RNTI for a given HARQ process with the DCI received before the end of the expected transmission of the last PUSCH for that HARQ process, if the latter is scheduled by a DCI format 0_0 with CRC scrambled by a TC-RNTI or by an uplink (UL) grant in a RA response.

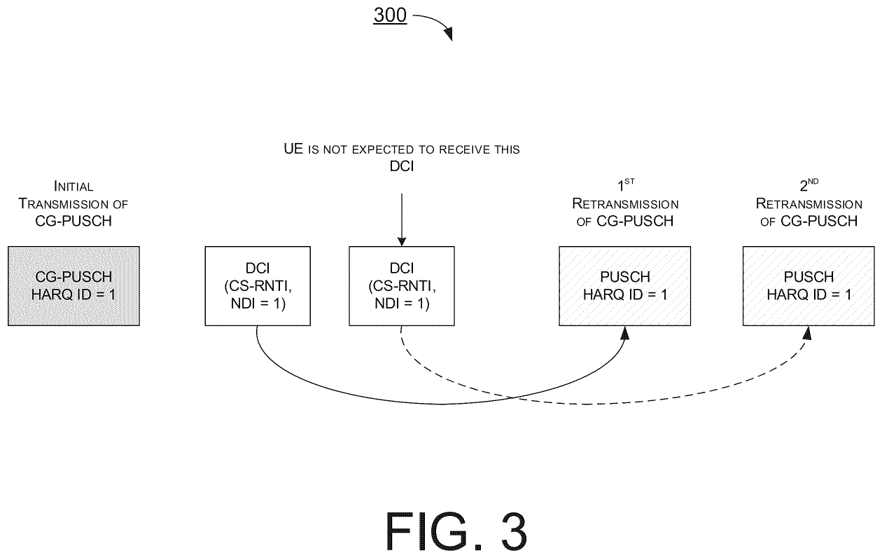

Under a second proposed scheme in accordance with the present disclosure, UE 110 may not expect to receive a DCI scrambled (e.g., CRC scrambled) by a CS-RNTI scheduling a transmission of a PUSCH for a given HARQ process until after an end of an expected transmission of a last PUSCH for that HARQ process in case that the PUSCH was scheduled with/by a DCI. FIG. 3 illustrates an example scenario 300 under this proposed scheme. Referring to FIG. 3, UE 110 is not expected to receive the DCI scheduled by a CS-RNTI.

As an example of an implementation of the second proposed scheme, UE 110 is not expected to be scheduled to transmit another PUSCH by DCI format 0_0 or 0_1 scrambled by a C-RNTI, CS-RNTI or MCS-C-RNTI for a given HARQ process with the DCI received before the end of the expected transmission of the last PUSCH for that HARQ process, if the latter is scheduled by a DCI with CRC scrambled by a C-RNTI, CS-RNTI or MCS-C-RNTI.

As another example of an implementation of the second proposed scheme, UE 110 is not expected to be scheduled to transmit another PUSCH by DCI format 0_0, 0_1 or 0_2 scrambled by a C-RNTI, CS-RNTI or MCS-C-RNTI for a given HARQ process with the DCI received before the end of the expected transmission of the last PUSCH for that HARQ process, if the latter is scheduled by a DCI with CRC scrambled by a C-RNTI, CS-RNTI or MCS-C-RNTI.

In each of the first and second proposed schemes, UE 110 may not be expected to be scheduled to transmit another PUSCH by DCI format 0_0 scrambled by a TC-RNTI for a given HARQ process until after an end of an expected transmission of a last PUSCH for that HARQ process. In each of the first and second proposed schemes, UE 110 may not be expected to be scheduled to transmit another PUSCH by DCI format 0_0 or 0_1 scrambled by a CS-RNTI for a given HARQ process until after an end of an expected transmission of a last PUSCH for that HARQ process in case that PUSCH was scheduled with/by a DCI.

In each of the first and second proposed schemes, in an event that UE 110 receives a DCI format 0_0 or 0_1 scrambled by a C-RNTI, MCS-C-RNTI or CS-RNTI scheduling a PUSCH for a given HARQ process, UE 110 may not be expected to receive another DCI format 0_0 or 0_1 scrambled by a C-RNTI, MCS-C-RNTI or CS-RNTI scheduling another PUSCH with the same HARQ process until after an end of a transmission of a last PUSCH for that HARQ process. In each of the first and second proposed schemes, in an event that UE 110 receives a DCI format 0_0 or 0_1 scrambled by a CS-RNTI scheduling a PUSCH for a given HARQ process, UE 110 may not be expected to receive another DCI format 0_0 or 0_1 scrambled by a CS-RNTI scheduling another PUSCH with the same HARQ process until after an end of a transmission of a last PUSCH for that HARQ process.

In each of the first and second proposed schemes, in an event that UE 110 receives a DCI format 0_0, 0_1 or 0_2 scrambled by a C-RNTI, MCS-C-RNTI or CS-RNTI scheduling a PUSCH for a given HARQ process, UE 110 may not be expected to receive another DCI format 0_0, 0_1 or 0_2 scrambled by a C-RNTI, MCS-C-RNTI or CS-RNTI scheduling another PUSCH with the same HARQ process until after an end of a transmission of a last PUSCH for that HARQ process. In each of the first and second proposed schemes, in an event that UE 110 receives a DCI format 0_0, 0_1 or 0_2 scrambled by a CS-RNTI scheduling a PUSCH for a given HARQ process, UE 110 may not be expected to receive another DCI format 0_0, 0_1 or 0_2 scrambled by a CS-RNTI scheduling another PUSCH with the same HARQ process until after an end of a transmission of a last PUSCH for that HARQ process. In each of the first and second proposed schemes, in an event that UE 110 receives a DCI scrambled by a CS-RNTI scheduling a PUSCH for a given HARQ process, UE 110 may not be expected to receive another DCI scrambled by a CS-RNTI scheduling another PUSCH with the same HARQ process until after an end of a transmission of a last PUSCH for that HARQ process.

### Illustrative Implementations

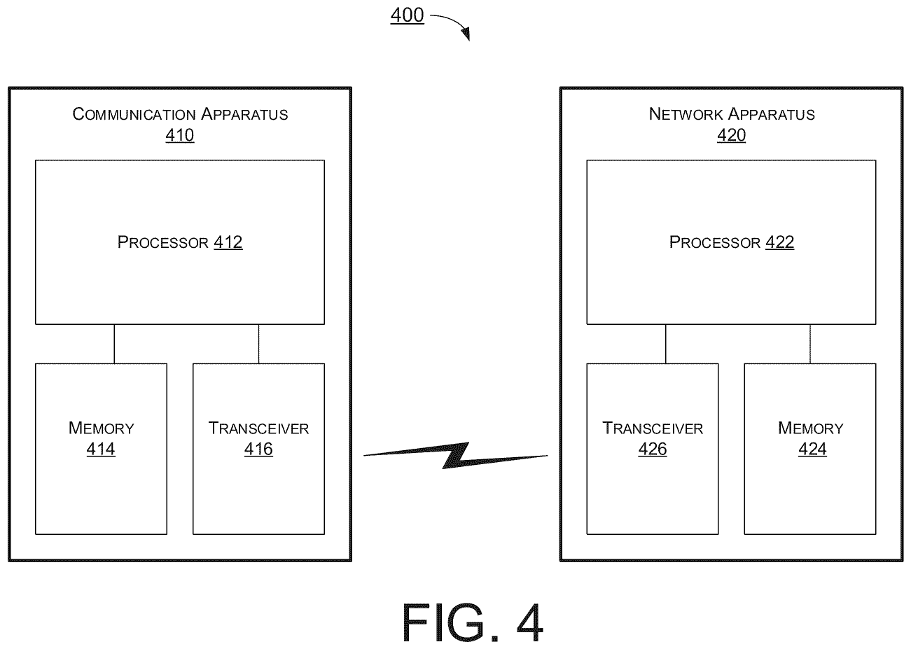

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to procedures for PUSCH scheduling in mobile communications, including scenarios/schemes described above as well as process(es) described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus/station, which may be a network node such as a base station, a small cell, a router, a gateway or a satellite. For instance, network apparatus 420 may be implemented in an eNodeB in an LTE, in a gNB in a 5G, NR, IoT, NB-IoT, IIoT, or in a satellite in an NTN network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 222 may be implemented in the form of one or more single-core processors, one or more multi-core processors, one or more RISC processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including new procedures for PUSCH scheduling in mobile communications in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

Each of communication apparatus 410 and network apparatus 420 may be a communication entity capable of communicating with each other using various proposed schemes in accordance with the present disclosure. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE (e.g., UE 110) and network apparatus 420 is implemented in or as a network node or base station (e.g., network node 125) of a communication network (e.g., wireless network 120). It is also noteworthy that, although the example implementations described below are provided in the context of mobile communications, the same may be implemented in other types of networks.

Under a proposed scheme pertaining to procedures for PUSCH scheduling in mobile communications in accordance with the present disclosure, with communication apparatus 410 implemented in or as UE 110 and network apparatus 420 implemented in or as network node 125 in network environment 100, processor 412 of communication apparatus 410 may perform, via transceiver 416, a last PUSCH transmission of one or more PUSCH transmissions associated with a given HARQ process (e.g., a first HARQ process among one or more HARQ processes) with network apparatus 420. Additionally, processor 412 may receive, via transceiver 416 after and not before the last PUSCH transmission, from network apparatus 420 a DCI signal scrambled by a specific RNTI and scheduling a subsequent PUSCH transmission for the given HARQ process. Moreover, processor 412 may perform, via transceiver 416, the subsequent PUSCH transmission for the given HARQ process with apparatus 420.

In some implementations, the specific RNTI may include a TC-RNTI. In such cases, the DCI signal may include a DCI format 0_0 that is CRC scrambled by the TC-RNTI.

In some implementations, the specific RNTI may include a CS-RNTI. In such cases, the DCI signal may include a DCI format 0_0 or 0_1 or 0_2.

In some implementations, the specific RNTI may include a C-RNTI. In such cases, the DCI signal may include a DCI format 0_0 or 0_1 or 0_2.

In some implementations, the specific RNTI may include an MCS-C-RNTI. In such cases, the DCI signal may include a DCI format 0_0 or 0_1 or 0_2.

Under another proposed scheme pertaining to procedures for PUSCH scheduling in mobile communications in accordance with the present disclosure, with communication apparatus 410 implemented in or as UE 110 and network apparatus 420 implemented in or as network node 125 in network environment 100, processor 412 of communication apparatus 410 may perform, via transceiver 416, a last PUSCH transmission of one or more PUSCH transmissions scheduled by a DCI signal and associated with a given HARQ process (e.g., a first HARQ process among one or more HARQ processes). Additionally, processor 412 may receive, via transceiver 416, the DCI signal scrambled by a specific RNTI and scheduling a subsequent PUSCH transmission for the given HARQ process. Moreover, processor 412 may skip the subsequent PUSCH transmission in an event that the DCI signal is received before the last PUSCH transmission.

In some implementations, the specific RNTI may include a TC-RNTI. In such cases, the DCI signal may include a DCI format 0_0 that is CRC scrambled by the TC-RNTI.

In some implementations, the specific RNTI may include a CS-RNTI. In such cases, the DCI signal may include a DCI format 0_0 or 0_1 or 0_2.

In some implementations, the specific RNTI may include a C-RNTI. In such cases, the DCI signal may include a DCI format 0_0 or 0_1 or 0_2.

In some implementations, the specific RNTI may include an MCS-C-RNTI. In such cases, the DCI signal may include a DCI format 0_0 or 0_1 or 0_2.

Under yet another proposed scheme pertaining to procedures for PUSCH scheduling in mobile communications in accordance with the present disclosure, with communication apparatus 410 implemented in or as UE 110 and network apparatus 420 implemented in or as network node 125 in network environment 100, processor 412 of communication apparatus 410 may perform, via transceiver 416, a last PUSCH transmission of one or more PUSCH transmissions associated with a given HARQ process (e.g., a first HARQ process among one or more HARQ processes) and scheduled by an UL grant in a RA response or by a DCI signal scrambled by a TC-RNTI. Additionally, processor 412 may receive, via transceiver 416, the DCI signal scrambled by the TC-RNTI and scheduling a subsequent PUSCH transmission for the given HARQ process. Moreover, processor 412 may skip the subsequent PUSCH transmission in an event that the DCI signal is received before the last PUSCH transmission.

In some implementations, the DCI signal may include a DCI format 0_0.

### Illustrative Processes

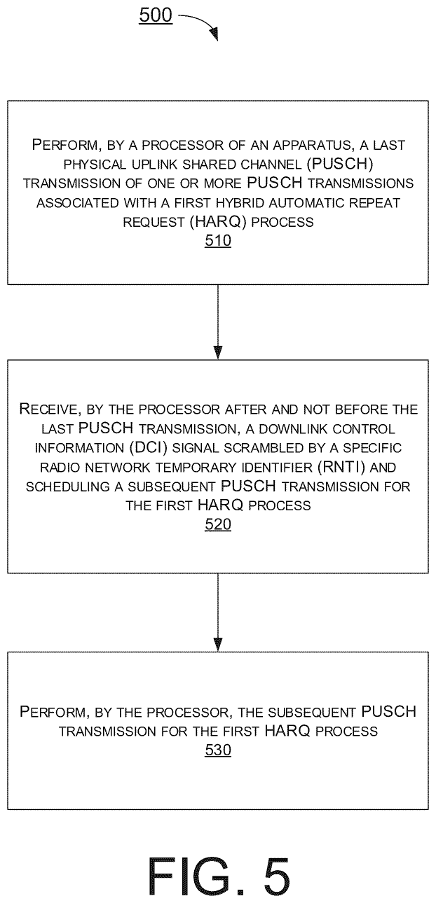

FIG. 5 illustrates an example process 500 in accordance with an implementation of the present disclosure. Process 500 may be an example implementation of schemes described above, whether partially or completely, with respect to procedures for PUSCH scheduling in mobile communications in accordance with the present disclosure. Process 500 may represent an aspect of implementation of features of communication apparatus 410 and/or network apparatus 420. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410 functioning as UE 110 and network apparatus 420 functioning as network node 125 in wireless network 120 (e.g., a 5G/NR mobile network). Process 500 may begin at block 510.

At 510, process 500 may involve processor 412 of communication apparatus 410 performing, via transceiver 416, a last PUSCH transmission of one or more PUSCH transmissions associated with a given HARQ process (e.g., a first HARQ process among one or more HARQ processes). Process 500 may proceed from 510 to 520.

At 520, process 500 may involve processor 412 receiving, via transceiver 416 after and not before the last PUSCH transmission, a DCI signal scrambled by a specific RNTI and scheduling a subsequent PUSCH transmission for the given HARQ process. Process 500 may proceed from 520 to 530.

At 530, process 500 may involve processor 412 performing, via transceiver 416, the subsequent PUSCH transmission for the given HARQ process.

In some implementations, the specific RNTI may include a TC-RNTI. In such cases, the DCI signal may include a DCI format 0_0 that is CRC scrambled by the TC-RNTI.

In some implementations, the specific RNTI may include a CS-RNTI. In such cases, the DCI signal may include a DCI format 0_0 or 0_1 or 0_2.

In some implementations, the specific RNTI may include a C-RNTI. In such cases, the DCI signal may include a DCI format 0_0 or 0_1 or 0_2.

In some implementations, the specific RNTI may include an MCS-C-RNTI. In such cases, the DCI signal may include a DCI format 0_0 or 0_1 or 0_2.

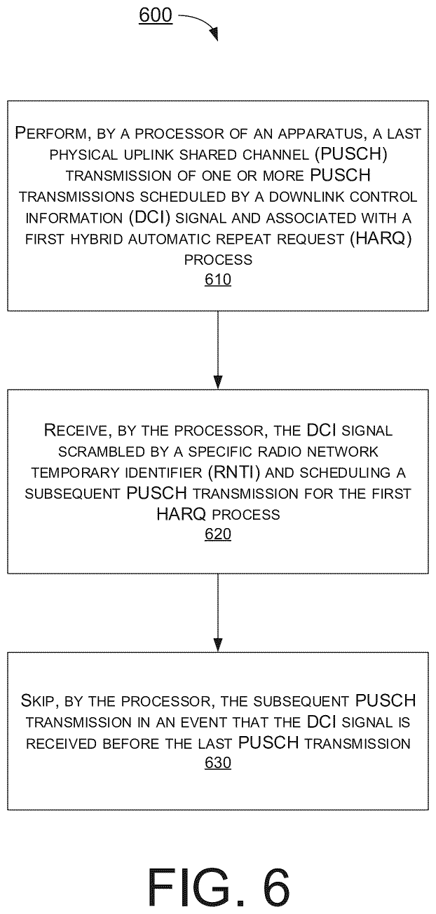

FIG. 6 illustrates an example process 600 in accordance with an implementation of the present disclosure. Process 600 may be an example implementation of schemes described above, whether partially or completely, with respect to procedures for PUSCH scheduling in mobile communications in accordance with the present disclosure. Process 600 may represent an aspect of implementation of features of communication apparatus 410 and/or network apparatus 420. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 410 or any suitable UE or machine type devices. Solely for illustrative purposes and without limitation, process 600 is described below in the context of communication apparatus 410 functioning as UE 110 and network apparatus 420 functioning as network node 125 in wireless network 120 (e.g., a 5G/NR mobile network). Process 600 may begin at block 610.

At 610, process 600 may involve processor 412 of communication apparatus 410 performing, via transceiver 416, a last PUSCH transmission of one or more PUSCH transmissions scheduled by a DCI signal and associated with a given HARQ process (e.g., a first HARQ process among one or more HARQ processes). Process 600 may proceed from 610 to 620.

At 620, process 600 may involve processor 412 receiving, via transceiver 416, the DCI signal scrambled by a specific RNTI and scheduling a subsequent PUSCH transmission for the given HARQ process. Process 600 may proceed from 620 to 630.

At 630, process 600 may involve processor 412 skipping the subsequent PUSCH transmission in an event that the DCI signal is received before the last PUSCH transmission.

In some implementations, the specific RNTI may include a TC-RNTI. In such cases, the DCI signal may include a DCI format 0_0 that is CRC scrambled by the TC-RNTI.

In some implementations, the specific RNTI may include a CS-RNTI. In such cases, the DCI signal may include a DCI format 0_0 or 0_1 or 0_2.

In some implementations, the specific RNTI may include a C-RNTI. In such cases, the DCI signal may include a DCI format 0_0 or 0_1 or 0_2.

In some implementations, the specific RNTI may include an MCS-C-RNTI. In such cases, the DCI signal may include a DCI format 0_0 or 0_1 or 0_2.

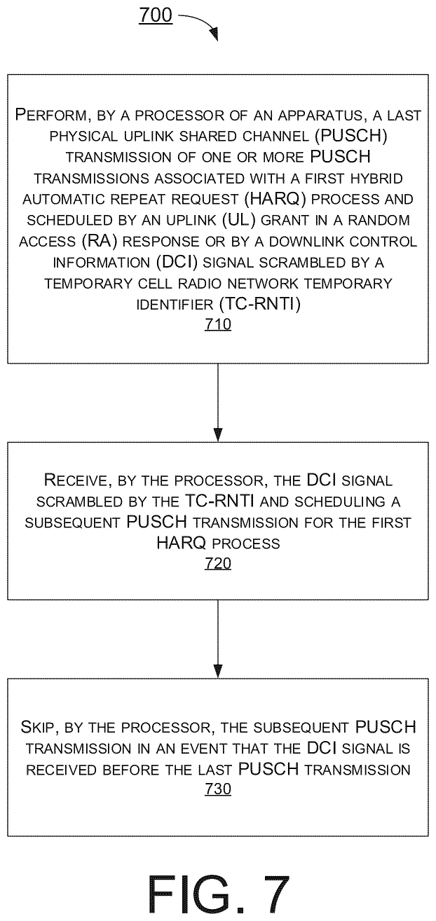

FIG. 7 illustrates an example process 700 in accordance with an implementation of the present disclosure. Process 700 may be an example implementation of schemes described above, whether partially or completely, with respect to procedures for PUSCH scheduling in mobile communications in accordance with the present disclosure. Process 700 may represent an aspect of implementation of features of communication apparatus 410 and/or network apparatus 420. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may be implemented by communication apparatus 410 or any suitable UE or machine type devices. Solely for illustrative purposes and without limitation, process 700 is described below in the context of communication apparatus 410 functioning as UE 110 and network apparatus 420 functioning as network node 125 in wireless network 120 (e.g., a 5G/NR mobile network). Process 700 may begin at block 710.

At 710, process 700 may involve processor 412 of communication apparatus 410 performing, via transceiver 416, a last PUSCH transmission of one or more PUSCH transmissions associated with a given HARQ process (e.g., a first HARQ process among one or more HARQ processes) and scheduled by an UL grant in a RA response or by a DCI signal scrambled by a TC-RNTI. Process 700 may proceed from 710 to 720.

At 720, process 700 may involve processor 412 receiving, via transceiver 416, the DCI signal scrambled by the TC-RNTI and scheduling a subsequent PUSCH transmission for the given HARQ process. Process 700 may proceed from 720 to 730.

At 730, process 700 may involve processor 412 skipping the subsequent PUSCH transmission in an event that the DCI signal is received before the last PUSCH transmission.

In some implementations, the DCI signal may include a DCI format 0_0.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
performing, by a processor of an apparatus, a last physical uplink shared channel (PUSCH) transmission of one or more PUSCH transmissions associated with a first hybrid automatic repeat request (HARQ) process; and
receiving, by the processor after and not before the last PUSCH transmission, a downlink control information (DCI) signal scrambled by a specific radio network temporary identifier (RNTI) and scheduling a subsequent PUSCH transmission for the first HARQ process.

2. The method of claim 1, wherein the specific RNTI comprises a temporary cell radio network temporary identifier (TC-RNTI).

3. The method of claim 2, wherein the DCI signal comprises a DCI format 0_0.

4. The method of claim 1, wherein the specific RNTI comprises a configured scheduling radio network temporary identifier (CS-RNTI).

5. The method of claim 4, wherein the DCI signal comprises a DCI format 0_0 or 0_1 or 0_2.

6. The method of claim 1, wherein the specific RNTI comprises a cell radio network temporary identifier (C-RNTI).

7. The method of claim 6, wherein the DCI signal comprises a DCI format 0_0 or 0_1 or 0_2.

8. The method of claim 1, wherein the specific RNTI comprises a modulation coding scheme (MCS) cell radio network temporary identifier (MCS-C-RNTI).

9. The method of claim 8, wherein the DCI signal comprises a DCI format 0_0 or 0_1 or 0_2.

10. A method, comprising:
performing, by a processor of an apparatus, a last physical uplink shared channel (PUSCH) transmission of one or more PUSCH transmissions scheduled by a downlink control information (DCI) signal and associated with a first hybrid automatic repeat request (HARQ) process;
receiving, by the processor, the DCI signal scrambled by a specific radio network temporary identifier (RNTI) and scheduling a subsequent PUSCH transmission for the first HARQ process; and
skipping, by the processor, the subsequent PUSCH transmission in an event that the DCI signal is received before the last PUSCH transmission.

11. The method of claim 10, wherein the specific RNTI comprises a temporary cell radio network temporary identifier (TC-RNTI).

12. The method of claim 11, wherein the DCI signal comprises a DCI format 0_0.

13. The method of claim 10, wherein the specific RNTI comprises a configured scheduling radio network temporary identifier (CS-RNTI).

14. The method of claim 13, wherein the DCI signal comprises a DCI format 0_0 or 0_1 or 0_2.

15. The method of claim 10, wherein the specific RNTI comprises a cell radio network temporary identifier (C-RNTI).

16. The method of claim 15, wherein the DCI signal comprises a DCI format 0_0 or 0_1 or 0_2.

17. The method of claim 10, wherein the specific RNTI comprises a modulation coding scheme (MCS) cell radio network temporary identifier (MCS-C-RNTI).

18. The method of claim 17, wherein the DCI signal comprises a DCI format 0_0 or 0_1 or 0_2.

19. A method, comprising:
performing, by a processor of an apparatus, a last physical uplink shared channel (PUSCH) transmission of one or more PUSCH transmissions associated with a first hybrid automatic repeat request (HARQ) process and scheduled by an uplink (UL) grant in a random access (RA) response or by a downlink control information (DCI) signal scrambled by a temporary cell radio network temporary identifier (TC-RNTI);
receiving, by the processor, the DCI signal scrambled by the TC-RNTI and scheduling a subsequent PUSCH transmission for the first HARQ process; and
skipping, by the processor, the subsequent PUSCH transmission in an event that the DCI signal is received before the last PUSCH transmission.

20. The method of claim 19, wherein the DCI signal comprises a DCI format 0_0.
